(19) United States
(12) Patent Application Publication
(10) Pub. No.: US 2005/0265445 A1
(43) Pub. Date: Dec. 1, 2005

(54) Transcoding videos based on different transformation kernels

(76) Inventors: Jun Xin, Quincy, MA (US); Anthony Vetro, Cambridge, MA (US); Huifang Sun, Billerica, MA (US)

Correspondence Address: Patent Department;Mitsubishi Electric Research Laboratories, Inc., 201 Broadway, Cambridge, MA, 02139, US

(21) Appl. No.: 10/858,109

(22) Filed: Jun. 1, 2004

(51) Int. Cl. H04N 7/12

(52) U.S. Cl. 375/240.2; 375/240.12; 375/240.03; 375/240.23

(57) ABSTRACT

A method and system transcodes an input video based on a first transformation kernel to an output video based on a second transformation kernel. The first and second transformation kernels are different, and the transcoding is performed entirely in a transform-domain. Coefficients of a single transform kernel matrix are determined. Then, input coefficients of the input video are converted to output coefficients of the output video using only the single transform kernel matrix. The input video can be based on DCT coefficients, and the output video can be based on HT coefficients. Alternatively, the input video can be based on HT coefficients, and the output video can be based on DCT coefficients. In addition, the ouput video can have a reduced a spatial resolution from the input video.

### RELATED APPLICATION

This application is related to U.S. patent application Ser. No. ______, “Selecting Macroblock Coding Modes for Video Encoding,” co-filed herewith by Xin et al., on Jun. 1, 2004, and incorporated herein by reference.

### FIELD OF THE INVENTION

The invention relates generally to transcoding of compressed videos, and more specifically, to transcoding of compressed videos based on different transformation kernels.

### BACKGROUND OF THE INVENTION

MPEG-2 is a video-coding standard developed by the Motion Picture Expert Group (MPEG) of ISO/IEC. It is currently the most widely used video coding standard. Its applications include digital television broadcasting, direct satellite broadcasting, DVD, video surveillance, etc. The transform used in MPEG-2, as well as a variety of other video coding standards, is a discrete cosine transform (DCT). Therefore, an MPEG encoded video uses DCT coefficients.

Advanced video coding according to the H.264/AVC standard is intended to significantly improve compression efficiency over earlier standards, including MPEG-2. This standard is expected to have a broad range of applications including efficient video storage, video conferencing, and video broadcasting over a digital subscriber link (DSL). The AVC standard uses a low-complexity integer transform, hereinafter referred to as HT. Therefore, an encoded AVC video uses HT coefficients.

With the deployment of H.264/AVC, e.g., for mobile broadcasts, there is a need to convert video in the MPEG-2 format to videos in the H.264/AVC format. This would enable more efficient network transmission and storage. In addition, there is also a need to convert from H.264/AVC videos to MPEG-2 videos so that legacy MPEG-2 devices can process videos encoded according to the later H.264/AVC format.

A transcoder simply decodes an encoded input video in an input format to reconstruct the image pixels of the original video and then reencodes the decoded video in an ouput format. This is referred to as pixel-domain transcoding. With this pixel-domain transcoding, the transform coefficients must be mapped from the source format to the destination format.

FIG. 1 shows a prior art pixel-domain conversion of transform coefficients from the MPEG-2 format to the H.264/AVC format, i.e., a DCT-to-HT conversion. The input is an 8×8 block (X) 101 of DCT coefficients. An inverse DCT (IDCT) 110 is applied to the block 101 to recover an 8×8 block (x) of original image pixels 102.

The 8×8 block of pixels 102 is divided evenly into four 4×4 blocks (x₁, x₂, x₃, x₄) 103. Each of the four blocks 103 is passed to a corresponding HT 120 to generate four 4×4 blocks 104 of transform coefficients Y₁, Y₂, Y₃ and Y₄. The four blocks of transform coefficients are combined to form a single 8×8 block (Y) 105. This is repeated for all blocks of the video.

FIG. 2 shows a pixel-domain conversion of transform coefficients from the AVC format to the MPEG format, i.e., HT-to-DCT conversion. Each of the four 4×4 blocks of HT coefficients 201, YY₁, YY₂, YY₃ and YY₄, are subject to an inverse HT 210 to generate four 4×4 pixel-blocks xx₁, xx₂, xx₃ and xx₄, which are combined to form a single 8×8 pixel block 202. Then, the pixel block xx is scaled 220 and subjected to a DCT 230 to produce the 8×8 DCT coefficient-block, (XX) 203.

This is repeated for all blocks of the video.

It is desired to perform the transcoding entirely in the compressed or transform-domain, then reconstructing the image pixels is avoided. Transform-domain transcoding could be more efficient than the prior art pixel-domain transcoding because complete decoding and reencoding are not required.

Transform-domain transcoding requires conversion between input and output transform coefficients of the input and output video formats. This conversion is trivial when the input and output formats are identical because both formats are based on the same transformation kernel.

However, up to now, transform-domain transcoding between different input and output formats with different transformation kernels has not been possible because a method that directly converts transform coefficients that are based on different transformation kernels does not exist.

Therefore, there exists a need to provide a direct conversion between transform-coefficients of videos having different transformation kernels.

### SUMMARY OF THE INVENTION

The invention transcodes an input video based on a first transformation kernel to an output video based on a second transformation kernel. The first and second transformation kernels are different, and the transcoding is performed entirely in a transform-domain. Coefficients of a single transform kernel matrix are determined. Then, input coefficients of the input video are converted to output coefficients of the output video using only the single transform kernel matrix.

The input video can be based on DCT coefficients, and the output video can be based on HT coefficients. Alternatively, the input video can be based on HT coefficients, and the output video can be based on DCT coefficients. In addition, the output video can have a reduced a spatial resolution from the input video.

### BRIEF DESCRIPTION OF THE DRAWINGS

FIG. 1 is a block diagram of a prior art pixel-domain DCT-to-HT conversion;

FIG. 2 is a block diagram of a prior art pixel-domain HT-to-DCT conversion;

FIG. 3 is a block diagram of a transform-domain DCT-to-HT conversion according to the invention;

FIG. 4 is a block diagram of a transform-domain HT-to-DCT conversion according to the invention;

FIG. 5 is a flow-graph of an embodiment of a 1D transform-domain DCT-to-HT conversion according to the invention;

FIG. 6 is a flow-graph of an embodiment of a 1D transform-domain HT-to-DCT conversion according to the invention.

FIG. 7 is a diagram of a prior art pixel-domain DCT-to-HT conversion with down sampling;

FIG. 8 is a diagram of a transform-domain DCT-to-HT conversion with down sampling according to the invention;

FIG. 9 is a flow-graph of an embodiment of a 1D transform-domain DCT-to-HT conversion with down sampling according the invention;

FIG. 10A is a block diagram of transcoding from an input MPEG-2 format to an output H.264/AVC format using DCT-to-HT conversion according to the invention;

FIG. 10B is a diagram of transcoding from an input H.264/AVC format to an output MPEG-2 format using the HT-to-DCT conversion according to the invention; and

FIG. 10C is a diagram of transcoding from an input MPEG-2 format to an output H.264/AVC format with lower spatial resolution using DCT-to-HT conversion with spatial resolution reduction according to the invention.

### DETAILED DESCRIPTION OF THE PREFERRED EMBODIMENT

Our invention provides a method and system for transcoding an input video format based on a first transformation kernel to an output video format based on a second transformation kernel, where the first and second transformation kernels are different and the transcoding is performed entirely in the transform domain. Such a transcoding can be applied to the transcoding between MPEG-2 and H.264/AVC formats.

We describe a method for direct DCT-to-HT conversion, a method for direct HT-to-DCT conversion, as well as a method for direct DCT-to-HT conversion with down sampling to a lower resolution. In addition, fast algorithms and integer approximations to compute these various conversions are described.

We describe several transcoding systems that employ each of these conversions.

DCT-to-HT Conversion

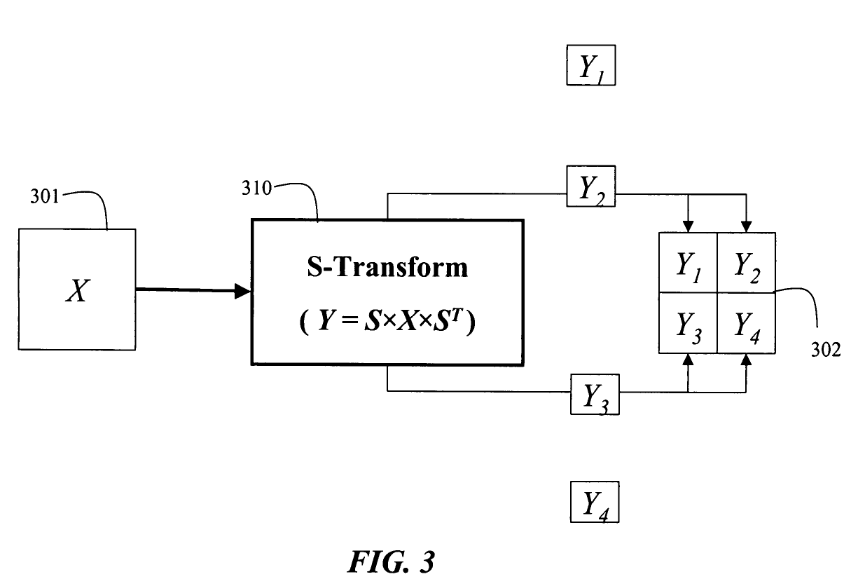

FIG. 3 shows a conversion of transform coefficients from DCT to HT in the transform-domain. The S-transform 310 is applied to input DCT coefficients (X) 301 of an input video in the MPEG format to produce output HT coefficients (Y) 302 of an output video in the AVC format.

The S-transform can be represented by a transform kernel matrix S, which is an 8×8 matrix:
Y=S×X×S^{T}, (1)

where S^{T} is the transpose of S. This transform is referred to as S-transform, and is described in further detail below.

The notation used in the derivation is as follows:
X—input DCT-coefficients in the form of an 8×8 matrix
Y—output HT-coefficients in the form of an 8×8 matrix
Y₁, Y₂, Y₃, Y₄—four 4×4 sub-blocks of Y
x—IDCT of X
x₁, x₂, x₃, x₄—four 4×4 sub-blocks of x
×—multiplication
(•)^{T}—matrix transpose
H—H.264/AVC transform kernel matrix

$$H = [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] \qquad ( 2 )$$
T₈—8×8 DCT transform kernel matrix

$${T}_{8} ( k , n ) = \frac{1}{2} {C}_{k} cos ( \frac{( 2 n + 1 ) k π}{16} ) , k , n = 0 , 1 , 2 , … , 7$$

$$where {C}_{k} = \{ \begin{matrix}1 / \sqrt{2} , & k = 0 \\ 1 , & k \neq 0\end{matrix}$$

The derivation of the S-transform is described below.

The HT transforms of x₁, x₂, x₃, and x₄ are Y₁, Y₂, Y₃, and Y₄, i.e.,
Y₁=H×x₁×H^{T} (3.1)
Y₂=H×x₂×H^{T} (3.2)
Y₃=H×x₃×H^{T} (3.3)
Y₄=H×x₄×H^{T}. (3.4)

If

$$HH = [ \begin{matrix}H & 0 \\ 0 & H\end{matrix} ] ,$$

then we can rewrite equations (3.1) through (3.4) into a single equation
Y=HH×x×HH^{T}, (4)

where x is the IDCT of X, i.e.,
x=T₈^{T}×X×T₈. (5)

It then follows that
Y=HH×T₈^{T}×X×T₈×HH^{T}. (6)

Comparing equation (6) with equation (1), we have
S=HH×T₈^{T} (7)

The direct DCT-to-HT transform is given by equation (1) and its transform kernel matrix S, rounded off to four decimal places, is:

| | | | | | | | | |
|---|---|---|---|---|---|---|---|---|
| S = | | | | | | | | |
| { | | | | | | | | |
| | 1.4142 | 1.2815 | 0 | −0.4500 | 0 | 0.3007 | 0 | −0.2549 |
| | 0 | 0.9236 | 2.2304 | 1.7799 | 0 | −0.8638 | −0.1585 | 0.4824 |
| | 0 | −0.1056 | 0 | 0.7259 | 1.4142 | 1.0864 | 0 | −0.5308 |
| | 0 | 0.1169 | 0.1585 | −0.0922 | 0 | 1.0379 | 2.2304 | 1.9750 |
| | 1.4142 | −1.2815 | 0 | 0.4500 | 0 | −0.3007 | 0 | 0.2549 |
| | 0 | 0.9236 | −2.2304 | 1.7799 | 0 | −0.8638 | 0.1585 | 0.4824 |
| | 0 | 0.1056 | 0 | −0.7259 | 1.4142 | −1.0864 | 0 | 0.5308 |
| | 0 | 0.1169 | −0.1585 | −0.0922 | 0 | 1.0379 | −2.2304 | 1.9750 |
| } | | | | | | | | |

HT-to-DCT Conversion

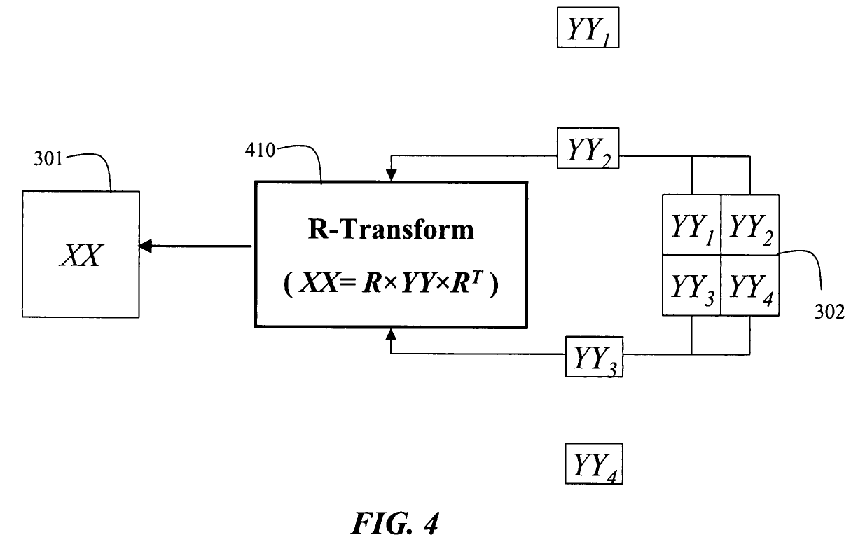

FIG. 4 shows coefficient mapping from HT to DCT in the transform-domain by directly mapping the HT coefficients, YY, 302 to the DCT coefficients, XX, 301, This mapping is represented as a transform 410 from YY to XX:
XX=R×YY×R^{T} (8)

This transform is referred to as R-transform in this invention.

The R-transform is not the inverse of the S-transform, i.e., the matrix R is not equal to the matrix S⁻¹, which is the inverse of S. The reason is that the transform kernel matrix of the inverse-HT is a not the inverse of the HT transform kernel matrix, H, but rather a scaled version of H⁻¹ to facilitate integer implementation. Therefore, we use the R-transform instead of the inverse S-transform to maintain this distinction.

The following are some additional notations:
YY—input HT-coefficients, in the form of an 8×8 matrix
XX—output DCT-coefficients, in the form of an 8×8 matrix
YY₁, YY₂, YY₃, YY₄—four 4×4 sub-blocks of YY
xx₁, xx₂, xx₃, xx₄—inverse HT of YY₁, YY₂, YY₃ and YY₄, 4×4 matrices
xx—combined from xx₁, xx₂, xx₃ and xx₄

The derivation of the R-transform is described below.

Let \tilde{H}ᵢₙᵥ be the inverse-HT transform kernel matrix, i.e.,

$$\begin{matrix}{\tilde{H}}_{inv} = [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] , and & ( 9 ) \\ {HH}_{inv} = [ \begin{matrix}{\tilde{H}}_{inv} & 0 \\ 0 & {\tilde{H}}_{inv}\end{matrix} ] . & ( 10 )\end{matrix}$$

Then, it follows that
xx=HHᵢₙᵥ×YY×HHᵢₙᵥ^{T}. (11)

The “scale” operation between the inverse HT and the DCT can be approximated by a divide operation. Therefore, we have

$$\begin{matrix}XX = {T}_{8} \times ( xx / 64 ) \times {T}_{8}^{T} \\ = ( {T}_{8} \times {HH}_{inv} \times YY \times {HH}_{inv}^{T} \times {T}_{8}^{T} ) / 64.\end{matrix} \qquad ( 12 )$$

By comparing equation (12) with equation (8), we obtain
R=(T₈×HHᵢₙᵥ)/8. (13)

The direct HT-to-DCT transform is given by equation (8) and its transform kernel matrix R, rounded off to four decimal places, is:

| | | | | | | | | |
|---|---|---|---|---|---|---|---|---|
| R = | | | | | | | | |
| { | | | | | | | | |
| | 0.1768 | 0 | 0 | 0 | 0.1768 | 0 | 0 | 0 |
| | 0.1602 | 0.0577 | −0.0132 | 0.0073 | −0.1602 | 0.0577 | 0.0132 | 0.0073 |
| | 0 | 0.1394 | 0 | 0.0099 | 0 | −0.1394 | 0 | −0.0099 |
| | −0.0562 | 0.1112 | 0.0907 | −0.0058 | 0.0562 | 0.1112 | −0.0907 | −0.0058 |
| | 0 | 0 | 0.1768 | 0 | 0 | 0 | 0.1768 | 0 |
| | 0.0376 | −0.0540 | 0.1358 | 0.0649 | −0.0376 | −0.0540 | −0.1358 | 0.0649 |
| | 0 | −0.0099 | 0 | 0.1394 | 0 | 0.0099 | 0 | −0.1394 |
| | −0.0319 | 0.0301 | −0.0663 | 0.1234 | 0.0319 | 0.0301 | 0.0663 | 0.1234 |
| } | | | | | | | | |

Fast DCT-to-HT Conversion

The sparseness and symmetry in S can be exploited to perform fast computation of the S-transform. Let values a, . . . , s be

a=1.4142, b=1.2815, c=0.45, d=0.3007, e=0.2549, f=0.9236, g=2.2304, h=1.7799, i=0.8638, j=0.1585, k=0.4824, l=0.1056, m=0.7259, n=1.0864, o=0.5308, p=0.1169, q=0.0922, r=1.0379, s=1.975.

We have S =

| { | | | | | | | | |
|---|---|---|---|---|---|---|---|---|
| | a | b | 0 | −c | 0 | d | 0 | −e |
| | 0 | f | g | h | 0 | −i | −j | k |
| | 0 | −l | 0 | m | a | n | 0 | −o |
| | 0 | p | j | −q | 0 | r | g | s |
| | a | −b | 0 | c | 0 | −d | 0 | e |
| | 0 | f | −g | h | 0 | −i | j | k |
| | 0 | l | 0 | −m | a | −n | 0 | o |
| | 0 | p | −j | −q | 0 | r | −g | s |
| } | | | | | | | | |

As suggested by equation (1), the 2D S-transform is a separable transform. Therefore, it can be achieved through 1D transforms, i.e., column transforms followed by row transforms. Hence, we described only the computation of the 1D transform.

Let z be an 8-point column vector, and a matrix Z be the 1D S-transform of z. The following steps provide a method to determine Z efficiently from z.
m1=a×z[1]
m2=b×z[2]−c×z[4]+d×z[6]−e×z[8]
m3=g×z[3]−j×z[7]
m4=f×z[2]+h×z[4]−i×z[6]+k×z[8]
m5=a×z[5]
m6=−1×z[2]+m×z[4]+n×z[6]−o×z[8]
m7=j×z[3]+g×z[7]
m8=p×z[2]−q×z[4]+r×z[6]+s×z[8]
Z[1]=m1+m2
Z[2]=m3+m4
Z[3]=m5+m6
Z[4]=m7+m8
Z[5]=m1−m2
Z[6]=m4−m3
Z[7]=m5−m6
Z[8]=m8−m7

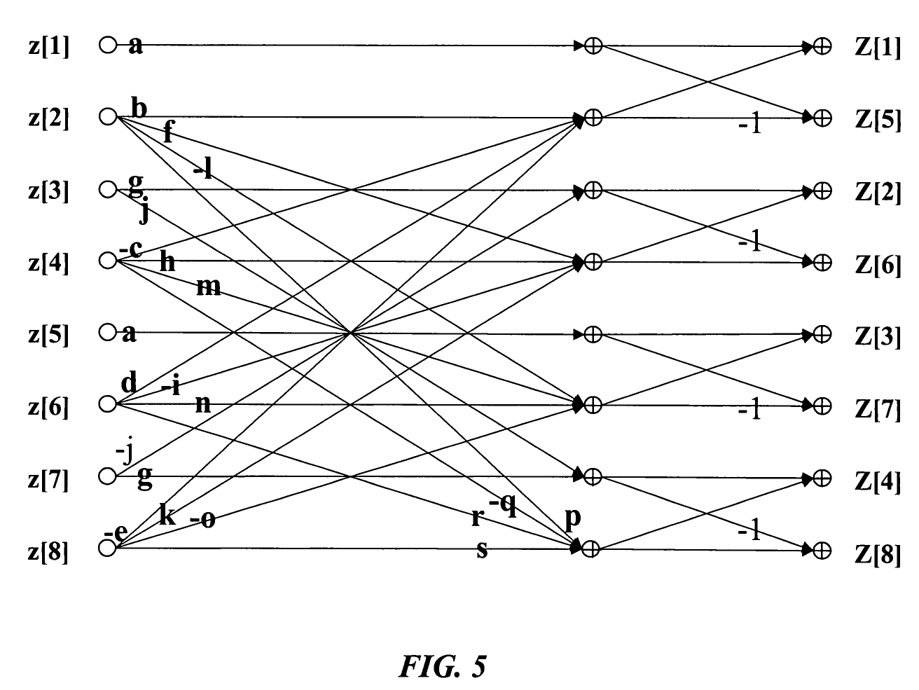

FIG. 5 shows the steps of this method using the values a, . . . , s as described above.

This method needs twenty-two multiplications and twenty-two additions. It follows that the 2-D S-transform needs 352 (16×22) multiplications and 352 (16×22) additions, for a total of 704 operations.

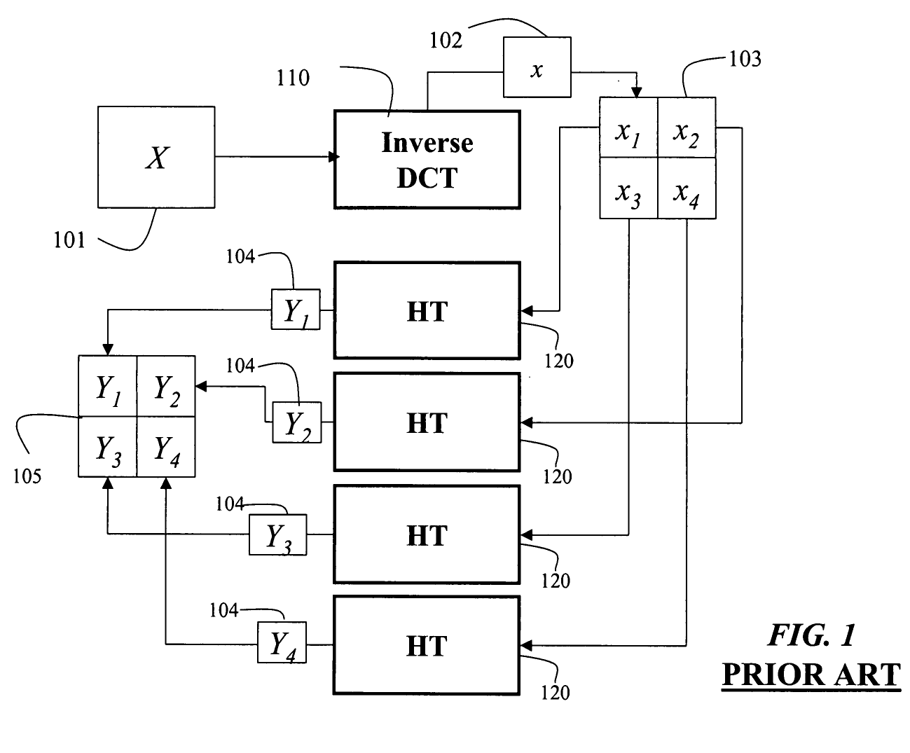

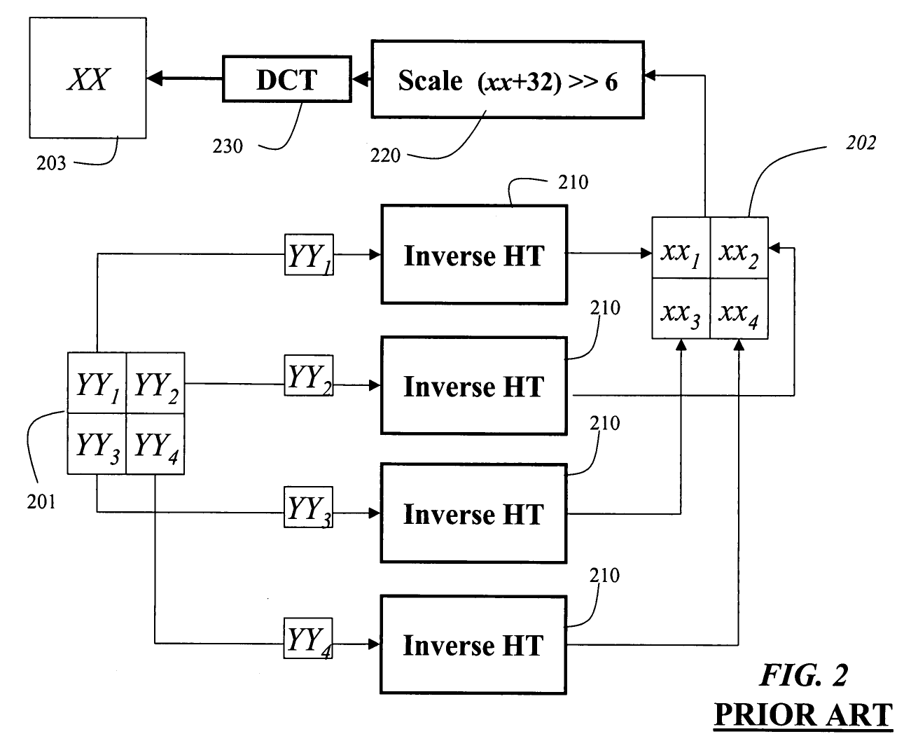

The pixel-domain implementation, as illustrated in FIG. 1, includes one IDCT and four HT transforms, see W. H. Chen, C. H. Smith, and S. C. Fralick, “A Fast Computational Algorithm for the Discrete Cosine Transform,” IEEE Trans. on Communications, Vol. COM-25, pp. 1004-1009, 1977. That implementation, often referred to as the reference IDCT, needs 256 (16×16) multiplications and 416 (16×26) additions. Each HT transform needs 16 (2×8) shifts and 64 (4×4) additions. The four HT transforms need 64 shifts and 256 additions. It follows that the overall computational requirements of the pixel-domain processing is 256 multiplications, 64 shifts and 672 additions, for a total of 992 operations.

Thus, the fast S-transform according to the invention saves about 30% of the operations when compared to the prior art pixel-domain implementation. In addition, the S-transform can be implemented in just two stages, whereas the prior art pixel-domain processing using the reference IDCT requires six stages.

Fast HT-to-DCT Conversion

Similar to the case of S-transform, let

aa=0.1768,bb=0.1602, cc=0.0562, dd=0.0376, ee=0.0319 ff=0.0577, gg=0.1394, hh=0.1112, ii=0.0540, jj=−0.0099, kk=0.0301, ll=0.0132, mm=0.0907, nn=0.1358, oo=0.0663, pp=0.0073, qq=0.0058, rr=0.0649, ss=0.1234.

| We have R = | | | | | | | | | |
|---|---|---|---|---|---|---|---|---|---|
| | { | | | | | | | | |
| | | aa | 0 | 0 | 0 | aa | 0 | 0 | 0 |
| | | bb | ff | −ll | pp | −bb | ff | ll | pp |
| | | 0 | gg | 0 | jj | 0 | −gg | 0 | −jj |
| | | −cc | hh | mm | −qq | cc | hh | −mm | −qq |
| | | 0 | 0 | aa | 0 | 0 | 0 | aa | 0 |
| | | dd | −ii | nn | rr | −dd | −ii | −nn | rr |
| | | 0 | −jj | 0 | gg | 0 | jj | 0 | −gg |
| | | −ee | kk | −oo | ss | ee | kk | oo | ss |
| | } | | | | | | | | |

As can be seen from equation (8), the 2D R-transform is also separable. It can be computed through 1D transforms, i.e., column transforms followed by row transforms. Hence, we show only the computation of the 1D transform. Let ZZ be an 8-point column vector, and zz be the 1D R-transform of ZZ. The following steps are for a method to determine zz from ZZ.
m1=ZZ[1]+ZZ[5]
m2=ZZ[1]−ZZ[5]
m3=ZZ[2]−ZZ[6]
m4=ZZ[2]+ZZ[6]
m5=ZZ[3]+ZZ[7]
m6=ZZ[3]−ZZ[7]
m7=ZZ[4]−ZZ[8]
m8=ZZ[4]+ZZ[8]
zz[1]=aa×m1
zz[2]=bb×m2+ff×m4−ll×m6+pp×m8
zz[3]=gg×m3+jj×m7
zz[4]=−cc×m2+hh×m4+mm×m6−qq×m8
zz[5]=aa×m5
zz[6]=dd×m2−ii×m4+nn×m6+rr×m8
zz[7]=−jj×m3+gg×m7
zz[8]=−ee×m2+kk×m4−oo×m6+ss×m8

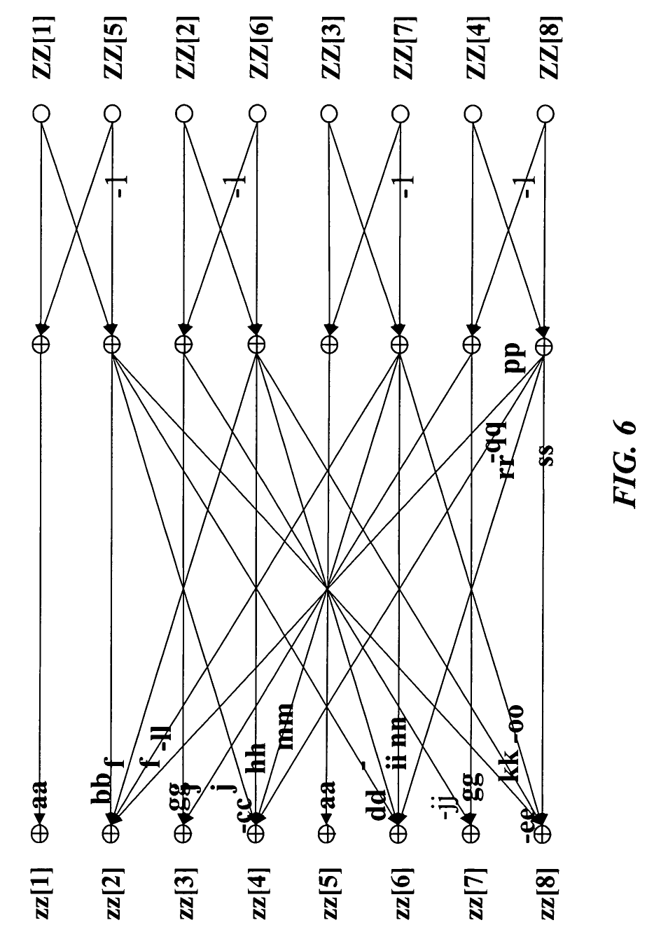

FIG. 6 shows a flow-graph representation of this method. It actually has the same nodes and connections as FIG. 5, but with reversed flow directions and different gains. Therefore, the complexity of the R-transform is same as the S-transform.

Integer Approximation of Fast DCT-to-HT Conversion

Floating-point operations are generally more expensive to implement than integer operations. Therefore, we also provide an integer approximation for the S-transform.

We multiply S by an integer that is a power of two, and use the integer transform kernel matrix to perform the operation using integer-arithmetic. Then, the resulting coefficients are scaled down by shifting. In video transcoding applications, the shifting operations can be absorbed during quantization. Therefore, no additional computations are required to use integer arithmetic.

The larger the integer we select, the more accuracy we may achieve. In many applications, the number is limited by the microprocessor on which the transcoding is performed. We describe how to choose the number such that the computation can be performed using 32-bit arithmetic, which is within the capability of most microprocessors.

For the case of the DCT-to-HT conversion, the DCT coefficients lie in the range of [−2048 to 2047]. This is a dynamic range of 4096, which needs 12 bits to represent. The gain of 2D S-transform is at most 42, which needs log₂(42)=5.4 bits. Therefore, 17.4 bits are needed to represent the final S-transform results. To be able to use 32-bit arithmetic, the scaling factor is made smaller than the square root of (2^{(32-17.4)}). The maximum integer satisfying this condition while being a power of two is 128.

Therefore, the integer transform kernel matrix is

| SI = round(S × 128) | | | | | | | | | |
|---|---|---|---|---|---|---|---|---|---|
| | = { | | | | | | | | |
| | | 181 | 164 | 0 | −58 | 0 | 38 | 0 | −33 |
| | | 0 | 118 | 285 | 228 | 0 | −111 | −20 | 62 |
| | | 0 | −14 | 0 | 93 | 181 | 139 | 0 | −68 |
| | | 0 | 15 | 20 | −12 | 0 | 133 | 285 | 253 |
| | | 181 | −164 | 0 | 58 | 0 | −38 | 0 | 33 |
| | | 0 | 118 | −285 | 228 | 0 | −111 | 20 | 62 |
| | | 0 | 14 | 0 | −93 | 181 | −139 | 0 | 68 |
| | | 0 | 15 | −20 | −12 | 0 | 133 | −285 | 253 |
| | } | | | | | | | | |

Comparing SI with S, we notice that the number of zero elements and the symmetry remain the same. Therefore, the method and flow-graph derived for the S-transform are also applicable to the integer approximation, as long as the values a through s are replaced with the corresponding elements of the matrix SI, instead of S.

Integer Approximation of Fast HT-to-DCT Conversion

We also provide the integer approximation of the method for the R-transform. We multiply an integer that is a power of two, and use the integer transform kernel to perform the operation using integer-arithmetic. Then, the resulting coefficients are scaled down through shifting.

For the case of HT-to-DCT conversion, the HT coefficients have a 12-bit dynamic range. The gain of 2D R-transform is at most 0.3416, which actually reduces the dynamic range to 11-bit. To be able to use 32-bit arithmetic, the scaling factor must be smaller than square root of (2⁽³²⁻¹¹⁾). The maximum integer satisfying this condition while being a power of 2 is 1024.

Therefore, the integer transform kernel matrix is

| RI = round(R × 1024) | | | | | | | | | |
|---|---|---|---|---|---|---|---|---|---|
| | = { | | | | | | | | |
| | | 181 | 0 | 0 | 0 | 181 | 0 | 0 | 0 |
| | | 164 | 59 | −14 | 7 | −164 | 59 | 14 | 7 |
| | | 0 | 143 | 0 | 10 | 0 | −143 | 0 | −10 |
| | | −58 | 114 | 93 | −6 | 58 | 114 | −93 | −6 |
| | | 0 | 0 | 181 | 0 | 0 | 0 | 181 | 0 |
| | | 38 | −55 | 139 | 66 | −38 | −55 | −139 | 66 |
| | | 0 | −10 | 0 | 143 | 0 | 10 | 0 | −143 |
| | | −33 | 31 | −68 | 126 | 33 | 31 | 68 | 126 |
| | } | | | | | | | | |

Comparing RI with R, we notice that the number of zero elements and the symmetry remain the same. Therefore, the method and flow-graph derived for R-transform are also applicable to the integer approximation, as long as the values aa through ss are replaced with the corresponding elements of the matrix RI, instead of R.

DCT-to-HT Down Sampling Conversion

For MPEG-2 to H.264/AVC transcoding with spatial resolution reduction, the DCT-to-HT coefficient conversion with down sampling is useful.

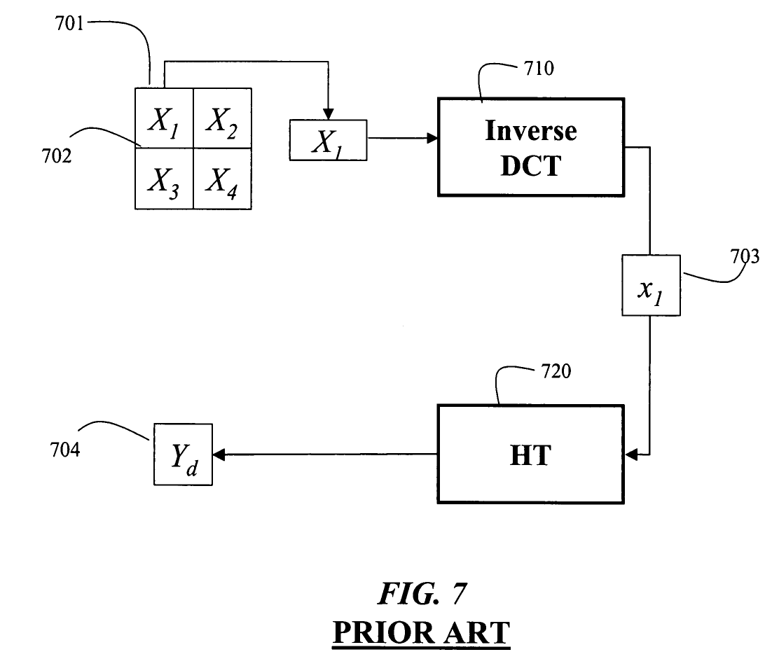

FIG. 7 shows a diagram of a prior art pixel-domain coefficient conversion with down sampling from DCT to HT. The upper-left 4×4 block 701, i.e., the low-frequency coefficients, X₁, of the input DCT-coefficients 702, is subject to inverse DCT transform 710 to generate a 4×4 pixel block, x₁, 703, which is then subject to HT transform 720 to produce the HT coefficient-block Y_{d} 704.

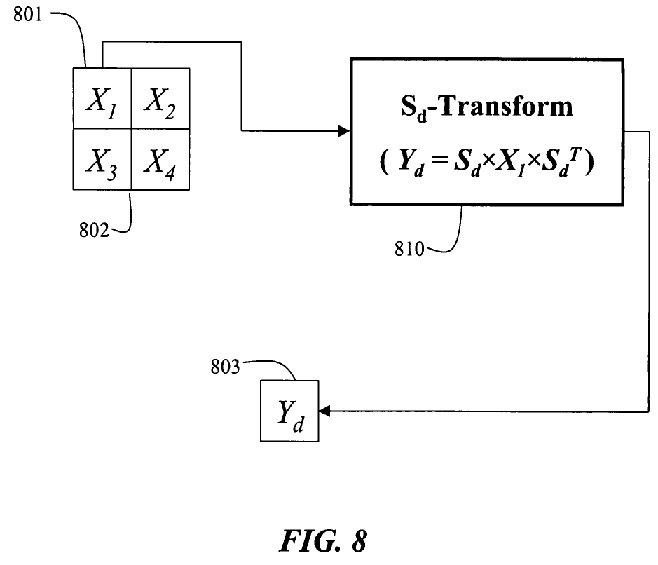

FIG. 8 shows DCT-to-HT conversion in the transform-domain with down sampling and the conversion of the DCT coefficients, X, an 8×8 block, to HT coefficients, Y_{d}, a 4×4 block. As in the pixel-domain, only the upper-left 4×4 block, X₁, 801 of X 802 is used, and all other three blocks are discarded. The DCT-to-HT down sampling conversion can be represented as a transform 810 from X₁ to Y_{d} 803 using a transform kernel matrix S_{d}, which is a 4×4 matrix:
Y_{d}=S_{d}×X₁×S_{d}^{T} (14)

This transform is referred to as S_{d}-transform, and is described in further detail below.

Some notations used in the derivation are as follows:
X—input DCT-coefficients, an 8×8 matrix
Y_{d}—target HT-coefficients, a 4×4 matrix
X₁, X₂, X₃, X₄—four 4×4 sub-blocks of X
x₁—IDCT of X₁
T₄—4×4 DCT transform kernel matrix

$${T}_{4} ( k , n ) = \frac{1}{2} {C}_{k} cos ( \frac{( 2 n + 1 ) k π}{8} ) , k , n = 0 , 1 , 2 , 3$$

$$where {C}_{k} = \{ \begin{matrix}1 / \sqrt{2} , & k = 0 \\ 1 , & k \neq 0\end{matrix}$$

The derivation of the S_{d}-transform is provided below.

The inverse DCT of X₁ is x₁, i.e.,
x₁=T₄^{T}×X₁×T₄. (15)

The HT transform of x₁ is Y_{d}, i.e.,

$$\begin{matrix}{Y}_{d} = H \times x1 \times {H}^{T} \\ = H \times {T}_{4}^{T} \times {X}_{1} \times {T}_{4} \times {H}^{T} .\end{matrix}$$

Comparing equation (15) with equation (14), we have
S_{d}=H×T₄^{T}. (16)

The down sampling DCT-to-HT transform is given by equation (14) and its transform kernel matrix S_{d}, rounded off to four decimal places, is:

S_{d} = {

| | | | |
|---|---|---|---|
| 2 | 0 | 0 | 0 |
| 0 | 3.1543 | 0 | −0.2242 |
| 0 | 0 | 2 | 0 |
| 0 | 0.2242 | 0 | 3.1543 |

},

where α=2, β=3.1543, and γ=0.2242.

Following the same principle of the S-transform, we derive the method based on the sparseness of symmetry and the transform kernel matrix S_{d}.

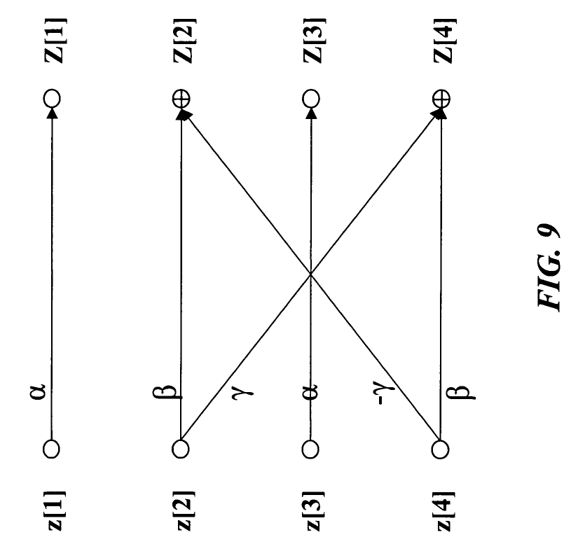

FIG. 9 shows the flow-graph of the method for 1-D S_{d} transform. The 2-D transform is also separable and can be implemented using 1-D transforms.

The DCT coefficients have a 12-bit dynamic range. The gain of 2D S_{d}-transform is at most 11.42, which increases the dynamic range to 15.52-bit. To be able to use 32-bit arithmetic, the scaling factor must be smaller than square root of (2^{(32-15.52)}). The maximum integer satisfying this condition while being a power of two is 256.

Therefore, the integer transform kernel matrix considering 32-bits arithmetic is given as follows:

SI_{d} = round(S_{d}×256)

| | |
|---|---|
| = | { |

| | 512 | 0 | 0 | 0 |
|---|---|---|---|---|
| | 0 | 808 | 0 | −57 |
| | 0 | 0 | 512 | 0 |
| | 0 | 57 | 0 | 808 |
| } | | | | |

The method for S_{d}-transform is also applicable to the integer approximation, as long as the values α through γ are replaced with the corresponding elements of the matrix SI_{d}, instead of S_{d}.

Transcoding

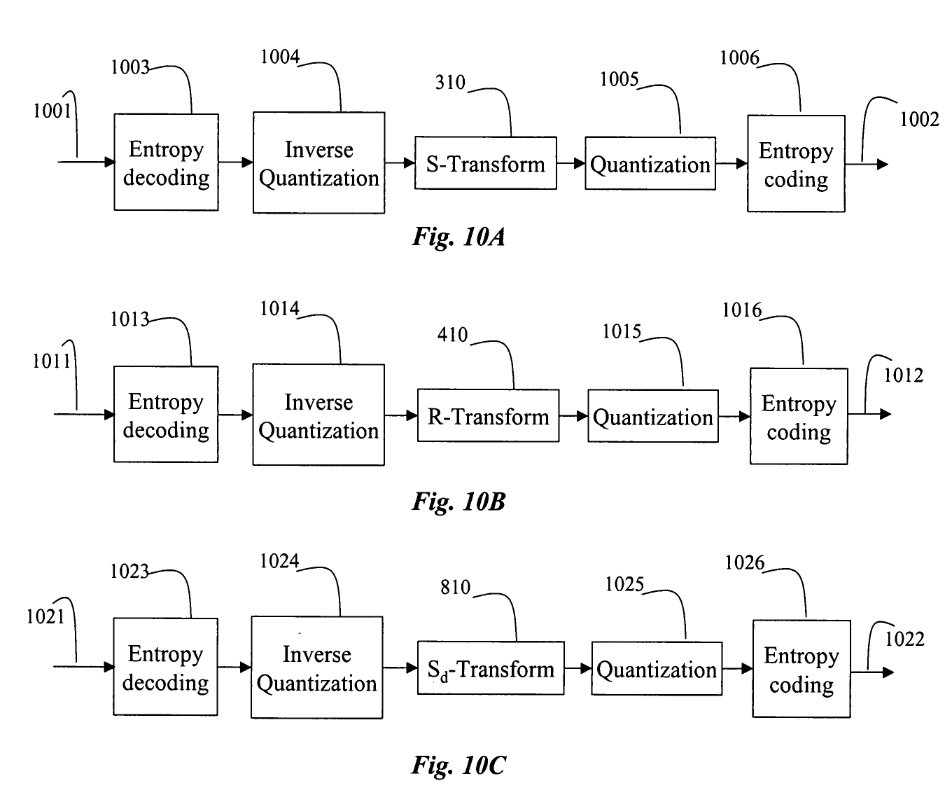

FIGS. 10A-C show how the transforms described in this invention are used for transcoding intra-frames.

FIG. 10A shows the block diagram for intra-frame transcoding from an input MPEG-2 format 1001 to an output H.264/AVC format 1002. The input is entropy-decoded 1003 and inverse-quantized 1004 to reconstruct the DCT coefficients, which are converted to HT coefficients using the S-Transform 310. The HT coefficients are then subject to quantization 1005 and entropy coding 1006 to generate the output H.264/AVC bitstream 1002.

FIG. 10B shows the block diagram for intra-frame transcoding from an input H.264/AVC format 1011 to an output MPEG-2 format 1012. The input is entropy-decoded 1013 and inverse-quantized 1014 to reconstruct the HT coefficients, which are converted to DCT coefficients using the R-Transform 410. The DCT coefficients are then subject to quantization 1015 and entropy coding 1016 to generate the output MPEG-2 bitstream 1012.

FIG. 10C shows the block diagram for intra-frame transcoding from an input MPEG-2 format 1021 to an output H.264/AVC format 1022, which has a lower spatial resolution. The input is entropy-decoded 1023 and inverse-quantized 1024 to reconstruct the DCT coefficients, which are then converted to HT coefficients of the lower spatial resolution using the S_{d}-Transform 810. The HT coefficients are subject to quantization 1025 and entropy coding 1026 to generate the output H.264/AVC bitstream 1022.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for transcoding an input video based on a first transformation kernel to an output video based on a second transformation kernel, where the first and second transformation kernels are different, comprising:
determining coefficients of a single transform kernel matrix; and
converting, entirely in a transform-domain, input coefficients of the input video to output coefficients of the output video using only the single transform kernel matrix.

2. The method of claim 1, in which the input video is based on DCT coefficients, and the output video is based on HT coefficients.

3. The method of claim 1, in which the input video is based on HT coefficients, and the output video is based on DCT coefficients.

4. The method of claim 1, in which the input video has an MPEG-2 encoding format, and the output video has an AVC encoding format.

5. The method of claim 1, in which the input video has an AVC encoding format, and the output video has an MPEG-2 encoding format.

6. The method of claim 1, further comprising reducing a spatial resolution while converting.

7. The method of claim 1, further comprising:
approximating the coefficients of the single transform kernel matrix by integer values.

8. The method of claim 7, further comprising:
scaling the coefficients of the single transform kernel matrix; and
rounding the scaled coefficients.

9. The method of claim 1, in which the input video includes intra-frames, and further comprising:
entropy decoding the intra-frames of the input video;
inverse quantizing the decoded intra-frames to reconstruct the input coefficients;
quantizing the ouput coefficients;
and entropy coding the quantized ouput coefficient to generate intra-frames of the output video.

10. A transcoder for converting an input video having an input format to an output video having an output format, the input and output formats being different, comprising:
a single transform kernel matrix; and
means for mapping input coefficients of the input video to output coefficients of the output video using only the single transform kernel matrix entirely in a transform-domain.
